(19) United States
(12) Patent Application Publication
(10) Pub. No.: US 2026/0078897 A1
(43) Pub. Date: Mar. 19, 2026

(54) Customizable Lighting System for Clothing and Accessories and Illuminating Clothing

(71) Applicant: John Williams, Charlotte, NC (US)

(72) Inventor: John Williams, Charlotte, NC (US)

(21) Appl. No.: 18/950,415

(22) Filed: Nov. 18, 2024

Related U.S. Application Data
(60) Provisional application No. 63/696,433, filed on Sep. 19, 2024.

(51) Int. Cl. F21V 33/00; F21L 4/08; F21V 23/04; F21V 31/00; F21W 121/06; F21Y 103/10; F21Y 115/10; H05B 45/20

(52) U.S. Cl. CPC F21V 33/0008; F21L 4/08; F21V 23/045; F21V 23/0464; F21V 23/0471; F21V 23/0492; F21V 31/00; H05B 45/20; A45B 3/04; F21W 2121/06; F21Y 2103/10; F21Y 2115/10

(57) ABSTRACT

The present invention relates to an illumination system integrated into various clothing items and accessories. The system comprises an array of lights, a power supply module, a control module, and a wireless remote-control unit. The lights include LED strips or individual LEDs which are embedded into the fabric or structure of the clothing item. The power supply module can include rechargeable or replaceable batteries or a flexible solar panel. The control module receives wireless control signals from the remote-control unit, which can be a smartphone with a software application that allows users to customize lighting patterns, colors, and frequencies. A voice-controlled activation module and motion sensors are included to alter the illumination based on user commands and movements.

### CROSS-REFERENCE TO RELATED APPLICATION

The present application claims priority to, and the benefit of, U.S. Provisional Application No. 63/696,433, which was filed on Sep. 19, 2024, and is incorporated herein by reference in its entirety.

### FIELD OF THE INVENTION

The present invention generally relates to illuminated clothing and accessories. More specifically, the invention relates to a customizable illuminating clothing. The clothing comprises an array of lights embedded into the fabric or structure, a power supply module with options like rechargeable batteries or flexible solar panels, and a control module wirelessly linked to a remote-control unit, such as a smartphone application. The users can personalize lighting patterns, colors, and frequencies. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, people often enjoy mixing and matching various outfits and accessories to express their personal style and create unique looks. Clothing and fashion accessories have traditionally been a way for individuals to showcase their identity, mood, and creativity. While conventional clothing and accessories come in numerous designs, colors, and patterns, they remain static in nature. Conventional clothing limits the user's ability to dynamically alter their appearance. Decorative clothing items, such as hats, shoes, and handbags, are popular choices for those looking to make a fashion statement. However, these items typically lack the capability to adapt or change their appearance in real-time to suit different moods, occasions, or environments.

In recent years, there has been a growing interest in innovative and interactive fashion accessories that go beyond static designs. Some individuals seek more exciting ways to enhance their outfits, such as integrating light-based elements. However, such garments lack the convenience of wireless control and customization of lights. People desire a new system that enhances the visual appeal of clothing and accessories.

Therefore, there exists a long-felt need in the art for an illumination system that allows users to enhance the visual appeal of clothing and accessories without being limited to static designs. There is a long-felt need for customizable clothing items that can dynamically change appearance with various lighting patterns and colors based on user preferences. Additionally, there is a long-felt need for a lighting system that integrates interactive features such as wireless control, motion sensing, and voice activation to provide a modern, engaging fashion experience. Moreover, there is a need for a system that can be seamlessly incorporated into different types of clothing items and accessories, such as hats, shoes, handbags, and walking canes, while remaining functional and aesthetically pleasing. Further, there is a need for an illumination system that can be controlled through a smart device, allowing users to customize their look conveniently. Finally, there is a long-felt need for a lighting solution that is safe, waterproof, and suitable for everyday use in various environments.

The subject matter disclosed and claimed herein, in one embodiment, comprises an advanced illumination system for clothing items and accessories. The system includes an array of lights, such as LED strips or individual LEDs, strategically embedded into the fabric, surface, or structure of the clothing item to maximize visual impact while maintaining usability. The system further includes a power supply module, which may consist of rechargeable or replaceable batteries or a flexible solar panel for power. The control module is adapted to adjust the light patterns, colors, and frequencies and is linked wirelessly to a remote-control unit, which may be a smartphone with a custom software application. Additionally, the system includes voice-controlled activation and a motion sensor to alter lighting patterns based on the user's movements, enhancing the interactive experience.

In this manner, the illumination system of the present invention accomplishes all of the foregoing objectives, providing a customizable, interactive, and versatile way to enhance clothing and accessories. The system allows users to change the visual appeal of their outfits dynamically, matching their style, mood or occasion. The system provides an engaging and modern fashion experience tailored to individual preferences by incorporating wireless control, voice activation, and motion sensing. The integrated power supply options, including rechargeable batteries and solar panels, make the system practical for everyday use. Additionally, the waterproof design ensures that the lighting system is safe and durable for various environments and activities.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lighting system for integration into a clothing item or accessory. The system comprises an array of lights configured to be embedded into a fabric, surface, or structure of the clothing item or accessory. A power supply module is coupled to the array of lights, the power supply module comprises at least one of a rechargeable battery, a replaceable battery, or a flexible solar panel for providing electric power to the array of lights. A control module is configured to receive control signals from a remote-control unit and adjust light patterns, colors, and frequencies of the array of lights in response to the control signals. The remote-control unit is wirelessly coupled to the control module for transmitting the control signals to the control module, wherein the remote-control unit is configured to allow a user to control the light patterns, colors, and frequencies of the array of lights.

In another aspect, a motion sensor is integrated with the control module, wherein the motion sensor is adapted to detect motion of the clothing item or accessory and transmit motion data to the control module, causing the control module to alter the light patterns based on the motion data.

In another embodiment, a lighting system for clothing items or accessories is disclosed. The system includes an array of lights comprising one of LED strips or individual LEDs, embedded into a portion of a clothing item or accessory. A power supply module is electrically connected to the array of lights, the power supply module being in the form of one of rechargeable or replaceable battery or a flexible solar panel. A control module is embedded within the clothing item or accessory and connected to the array of lights, the control module being adapted to control illumination patterns, colors, and frequencies of the array of lights. A voice-controlled activation module is integrated with the control module, configured to receive vocal commands from a user to activate the array of lights. A wireless communication channel is configured to link the control module with a remote-control unit, wherein the remote-control unit includes a customized software application for controlling the illumination patterns, colors, and frequencies of the array of lights.

In another embodiment, a clothing item is disclosed. The clothing item includes a fabric or surface structure configured to be worn by a user, an embedded lighting system within the fabric or surface structure, the system includes an array of lights strategically embedded into the fabric or surface structure, a power supply module for supplying electric power to the array of lights, a control module connected to the array of lights, wherein the control module is adapted to receive wireless control signals and adjust light patterns, colors, and frequencies of the array of lights based on the wireless control signals, and a remote-control unit adapted to transmit the wireless control signals to the control module, allowing the user to select different lighting patterns, colors, and frequencies for the array of lights.

In yet another aspect, a method of controlling an illumination system integrated into a clothing item or accessory is disclosed. The method includes embedding an array of lights into a fabric or surface of the clothing item or accessory, coupling a power supply module to the array of lights to provide electric power to the array, receiving, via a control module embedded within the array of lights, a wireless control signal from a remote-control unit, adjusting, via the control module, the light patterns, colors, and frequencies of the array of lights based on the received control signal, and altering the light patterns of the array of lights.

In one embodiment, the method includes detecting, through a motion sensor embedded in the clothing item or accessory, movement of the clothing item or accessory, transmitting motion data from the motion sensor to the control module, and altering the light patterns of the array of lights based on the detected movement to enhance the visual appeal and personalization of the clothing item or accessory.

In yet another aspect, the wireless control signal is transmitted from a software application installed on a smartphone. The method also includes synchronizing the illumination system with external media, wherein the software application receives audio data and automatically adjusts the light patterns and colors of the array of lights to correspond with the rhythm and tempo of the audio.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram of a lighting system of the present invention for an article of clothing in accordance with one embodiment;

FIG. 2 illustrates a front view of a shoe with an embedded lighting system in accordance with one embodiment of the present invention;

FIG. 3 illustrates a perspective view of an illuminating hat of the present invention in accordance with the disclosed structure;

FIG. 4 illustrates a perspective view of a walking cane in accordance with one embodiment of the present invention; and

FIG. 5 illustrates a schematic view showing the connection of the illuminating clothing of one embodiment of the present invention with the remote-control unit in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an illumination system that allows users to enhance the visual appeal of clothing and accessories without being limited to static designs. There is a long-felt need for customizable clothing items that can dynamically change appearance with various lighting patterns and colors based on user preferences. Additionally, there is a long-felt need for a lighting system that integrates interactive features such as wireless control, motion sensing, and voice activation to provide a modern, engaging fashion experience. Moreover, there is a need for a system that can be seamlessly incorporated into different types of clothing items and accessories, such as hats, shoes, handbags, and walking canes, while remaining functional and aesthetically pleasing. Further, there is a need for an illumination system that can be controlled through a smart device, allowing users to customize their look conveniently. Finally, there is a long-felt need for a lighting solution that is safe, waterproof, and suitable for everyday use in various environments.

The present invention, in one exemplary embodiment, is an illuminating clothing item. The clothing item includes a fabric or surface structure configured to be worn by a user, an embedded lighting system within the fabric or surface structure, the system includes an array of lights strategically embedded into the fabric or surface structure, a power supply module for supplying electric power to the array of lights, a control module connected to the array of lights, wherein the control module is adapted to receive wireless control signals and adjust light patterns, colors, and frequencies of the array of lights based on the wireless control signals, and a remote-control unit adapted to transmit the wireless control signals to the control module, allowing the user to select different lighting patterns, colors, and frequencies for the array of lights.

Reference will now be made in detail to the present preferred embodiments of the invention, examples of which are illustrated in the accompanying drawings. Wherever possible, the same reference numerals are used in the drawings and the description to refer to the same or like parts.

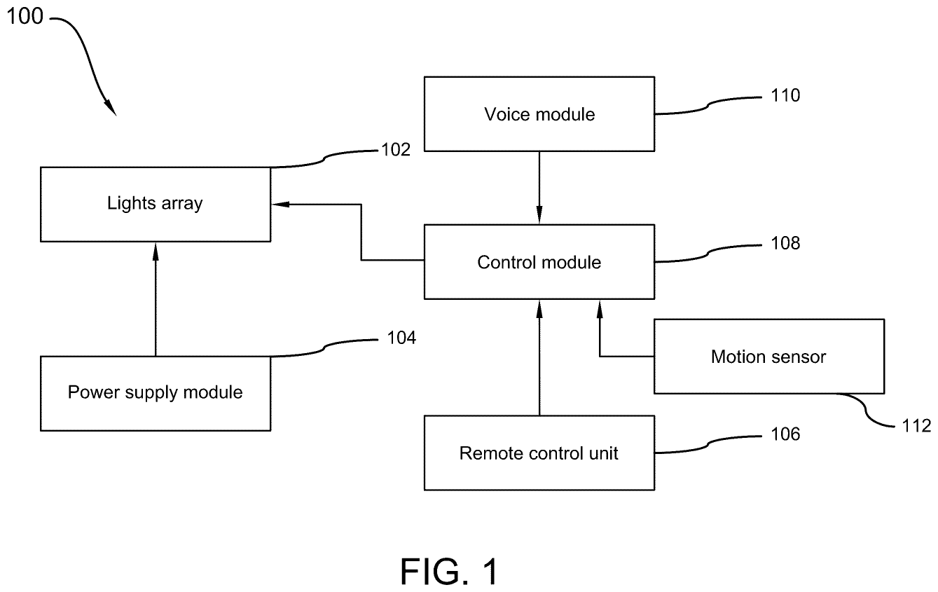

Referring initially to the drawings, FIG. 1 illustrates a block diagram of a customizable lighting system 100 of the present invention for clothing and accessories in accordance with one embodiment. The lighting system 100 of the present invention is designed as an illumination system that can be integrated into various clothing items and accessories, including hats, shoes, walking canes, handbags, and other fashion elements. The lighting system 100 enhances the visual appeal of clothing items using customizable lights that can be controlled wirelessly. More specifically, the lighting system 100 includes an array of lights 102, wherein the lights 102 can be LED strips or individual LED lights. The lights array 102 can be strategically embedded into a fabric, surface, or structure of a clothing item that maximizes visual impact while maintaining the usability of the lights array 102.

At least one power supply module 104 is included in the system 100 for providing electric power to the lights array 102. The power supply module 104 can be in the form of rechargeable or replaceable lithium-ion batteries (AA or AAA batteries). In some embodiments, the power supply module 104 is in the form of a flexible solar panel for providing electrical power to the array 102. A remote-control unit 106 is coupled to a control module 108 which is embedded in the array 102. The control module 108 of the lighting system 100 is adapted to adjust light patterns, colors, and frequencies of the individual (or collective) lights of the array 102. Further, the control module 108 receives wireless control signals from the remote-control unit 106 and processes the remote signals to adjust light patterns, colors, and frequencies as per the user's input. The remote-control unit 106 can be in the form of a physical control or a customized software application installed on a smartphone or other smart device for remotely controlling the lights array 102.

A voice-controlled activation module 110 is included in the system 100 which enables a user to speak a wake-up word such as, but not limited to, ‘ON’ to activate the lights array 102. A motion sensor 112 is included in the system 100 that is adapted to sense the motion of the clothing item in which the system 100 is installed. The motion sensor 112 transmits a control signal to the control module 108 that alters lighting patterns and/or lighting colors based on the user's movements. As an example, an embodiment wherein the system 100 is applied to a shoe 200 can illuminate in different patterns when the user is walking versus running. It will be apparent to a person skilled in the art that the lighting system 100 enhances the personal style of wearers of the clothing and offers users the ability to personalize their clothing and accessories with various lighting patterns and colors.

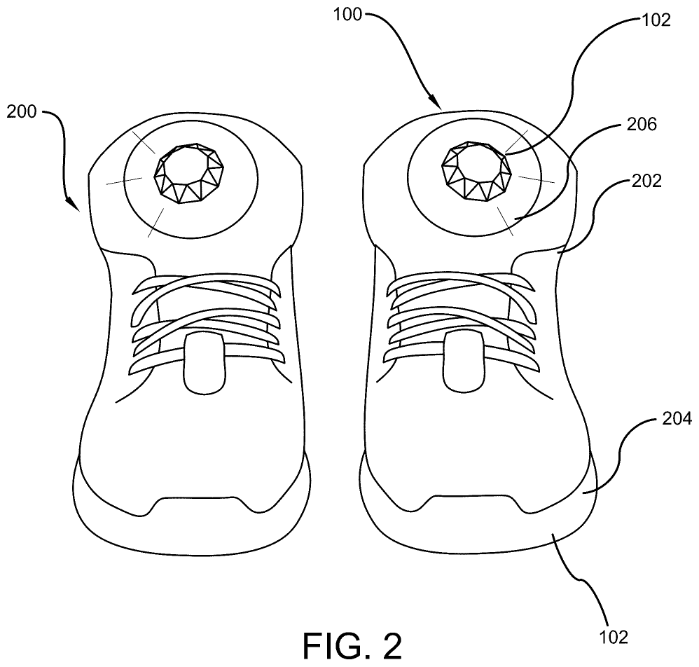

FIG. 2 illustrates a front view of a shoe 200 with an embedded lighting system 100 in accordance with one embodiment of the present invention. In the present embodiment, the lighting system 100 is installed on the tongue 202 and/or sole 204 of the shoes 200. The lighting system 100 can be integrated during the manufacturing of the illuminating shoe 200 or can also be attached as an aftermarket accessory. The light array 102 can be made for any size, design, or pattern for any article of clothing of men, women, children, and pets. The light array 102 can be distributed along different locations on the shoe 200 and can illuminate in different colors. In one embodiment, one or more wires 206 can connect the array 102 to the power module.

It should be noted that the lighting system 100 is insulated and waterproof to protect the system 100 from weather elements and eliminate the chance of the wearer being shocked by electricity provided by the power module 104. The system 100 can be sewn or embedded in the shoe 200 and can also be attached using adhesive or other fixed fastener.

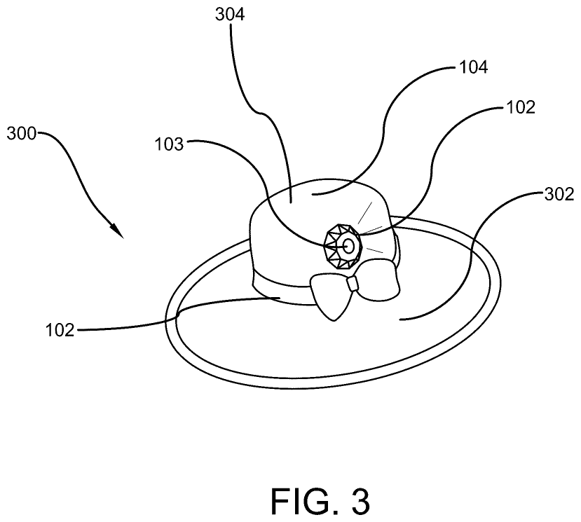

FIG. 3 illustrates a perspective view of an illuminating hat 300 of the present invention in accordance with the disclosed structure. In the present embodiment, the decorative hat 300 has a lights array 102 disposed on the front end 302 thereof, and the power module 104 which is preferably a bendable solar panel is disposed on the center 304 of the hat 300. A wearer of the hat 300 can give a voice command for illuminating the LEDs 102 and can use the remote-control unit 106 to change light patterns, colors, and frequencies of the LEDs.

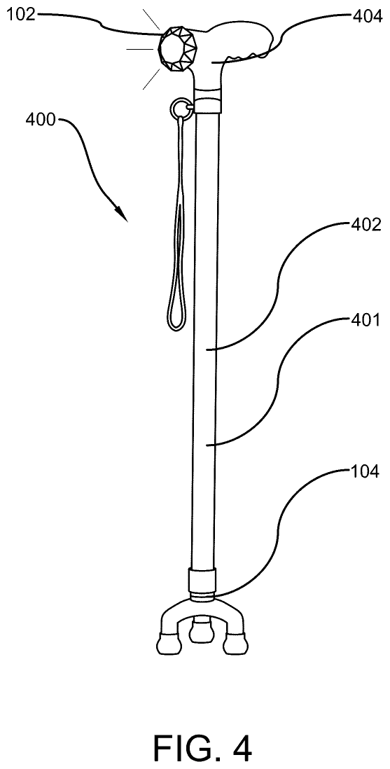

FIG. 4 illustrates a perspective view of a walking cane 400 in accordance with one embodiment of the present invention. As illustrated, the walking cane 400 includes lighting panel 102 on this stick 402 which can be used for decoration as well as for illumination in dark. The lighting panel 102 in the present embodiment is adapted to automatically flash light in dark using an embedded ambient light sensor 103. The wireless-controlled illuminated clothing system 100 can include wires 401 connecting the power module 104 which may be disposed along the stick 402 and the lighting panel 102 which is preferably disposed at the top end 404 of the stick 402.

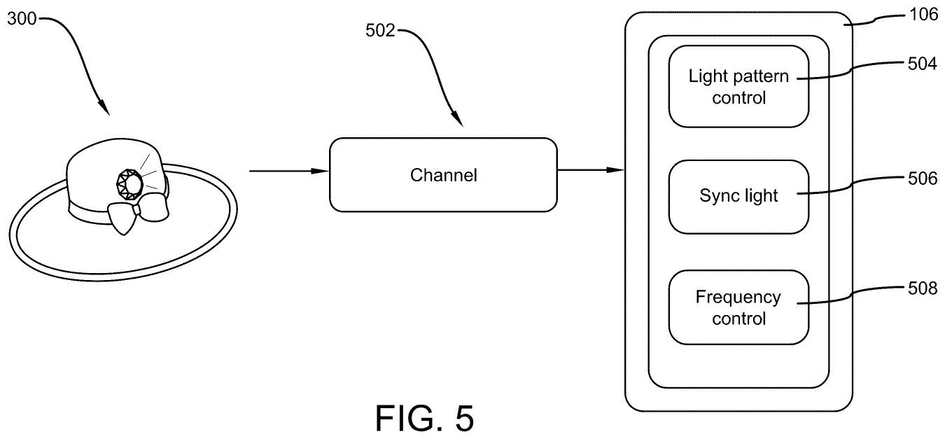

FIG. 5 illustrates a schematic view showing the connection of the wireless-controlled illuminated clothing system 100 of one embodiment of the present invention with the remote-control unit 106 in accordance with the disclosed structure. As illustrated, the clothing 300 can be coupled to the remote-control unit 106 via a short-range communication channel 502 such as Bluetooth or RF channel. The remote-control unit 106 provides a plurality of control options which can be in the form of physical buttons in the unit 106 or digital icons in a smartphone application. A light pattern control 504 enables a user to set an illumination pattern of the LEDs of the system 100. Different patterns including, but not limited to, chasing lights, alternating colors, or LEDs operating in unison can be selected for illumination.

A sync light option 506 when selected by a user enables the system 100 to automatically illuminate the LEDs based on a song or music being played in the smartphone which functions as the remote-control unit 106. The ability of the system 100 to create synchronized light enables a user to use the illuminated clothing in dance performances, themed parties, and promotional events to enhance visual appeal. A frequency control option 508 enables users to set the frequency of light flashing and allows users to match the lighting effect with their outfit or mood. The frequency changes the color of the illuminating light 102 enabling users to customize the illumination.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wireless-controlled illuminated clothing system”, “customizable lighting system for clothing and accessories”, “lighting system”, and “system” are interchangeable and refer to the customizable lighting system for clothing and accessories 100 of the present invention.

Notwithstanding the foregoing, the customizable lighting system for clothing and accessories 100 of the present invention can be of any suitable size and configuration as is known in the art without affecting the overall concept of the invention, provided that it accomplishes the above-stated objectives. One of ordinary skill in the art will appreciate that the customizable lighting system for clothing and accessories 100 as shown in the FIGS. are for illustrative purposes only, and that many other sizes and shapes of the customizable lighting system for clothing and accessories 100 are well within the scope of the present disclosure. Although the dimensions of the customizable lighting system for clothing and accessories 100 are important design parameters for user convenience, the customizable lighting system for clothing and accessories 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A wireless-controlled illuminated clothing system comprising:
a lights array sewn onto a clothing item, the lights array comprised of an LED light.
a power supply module for providing electric power to the lights array, the power supply module comprising a battery or a solar panel;
a control module coupled to the lights array, the control module configured to adjust a light pattern, a light color, and a frequency of the lights array in response to a control signal sent by the control module;
a remote-control unit configured to transmit a wireless control signal to the control module; and
a motion sensor integrated with the control module, wherein the motion sensor detects the movement of the clothing item and adjusts the light pattern or the light color based on detected motion; and
wherein the light pattern is altered based on whether a user is walking versus running.

2. The wireless-controlled illuminated clothing system of claim 1, wherein the battery is comprised of a rechargeable battery.

3. The wireless-controlled illuminated clothing system of claim 1, wherein the solar panel is comprised of a flexible solar panel.

4. The wireless-controlled illuminated clothing system of claim 1 further comprised of a voice-controlled activation module.

5. The wireless-controlled illuminated clothing system of claim 4, wherein the voice-controlled activation module responds to a word.

6. The wireless-controlled illuminated clothing system of claim 1, wherein the light pattern is altered based on a motion detected by the motion sensor.

7. The wireless-controlled illuminated clothing system of claim 1, wherein the lights array is waterproof.

8. The wireless-controlled illuminated clothing system of claim 1, wherein the clothing item is comprised of a shoe or a hat.

9. A wireless-controlled illuminated clothing system comprising:
a lights array adhesively attached to an accessory or a clothing item, the lights array comprising an LED light;
a power supply module operatively connected to the lights array, the power supply module comprising a rechargeable battery;
a control unit configured to modify a light pattern, a light color, or a light frequency of the lights array;
a wireless remote-control mechanism for sending a command to the control unit;
a voice-controlled activation module that allows activation of the lights array through a predefined vocal command; and
a sensor module comprising a motion sensor or a light sensor for automatically adjusting the light pattern, the light color, or the light frequency based on an external condition; and
wherein the light pattern comprises a chasing light pattern and an alternating color pattern.

10. The wireless-controlled illuminated clothing system of claim 9, wherein the wireless remote-control mechanism communicates with the control unit via Bluetooth.

11. The wireless-controlled illuminated clothing system of claim 9, wherein the light pattern can be synchronized to an audio.

12. The wireless-controlled illuminated clothing system of claim 9 further comprised of an LED strip.

13. The wireless-controlled illuminated clothing system of claim 9 further comprised of a solar panel.

14. A wireless-controlled illuminated clothing system comprising:
a lighting panel adhesively attached to a structural component of an accessory, the lighting panel comprising an LED light;
a power module connected to the lighting panel, wherein the power module comprises a replaceable battery or a flexible solar panel;
a control unit coupled to the lighting panel for regulating a behavior of the LED light;
a remote-control unit for wirelessly communicating with the control unit, the remote-control unit comprising a physical interface or a software;
a voice-activated module configured to illuminate the lighting panel upon detection of a predetermined voice command; and
a sensor module that detects a motion or an ambient light changes and adjusts an illumination of the lighting panel as a result; and
wherein the behavior of the LED light comprises a chasing light pattern and an alternating color pattern.

15. The wireless-controlled illuminated clothing system of claim 14, wherein the structural component is comprised of a handle of a cane.

16. The wireless-controlled illuminated clothing system of claim 14, wherein the structural component is comprised of a brim of a hat.

17. The wireless-controlled illuminated clothing system of claim 14, wherein the sensor module is comprised of a motion sensor.

18. The wireless-controlled illuminated clothing system of claim 14, wherein the lighting panel sensor module is comprised of an ambient light sensor.

19. The wireless-controlled illuminated clothing system of claim 14, wherein the lighting panel is waterproof.

20. The wireless-controlled illuminated clothing system of claim 14, wherein the lighting panel is comprised of an LED strip.
